(19) United States
(12) Patent Application Publication
(10) Pub. No.: US 2025/0369890 A1
(43) Pub. Date: Dec. 4, 2025

(54) GOLD NANOPARTICLES-EMBEDDED ZINC OXIDE NANOSHEETS AS SURFACE-ENHANCED RAMAN SCATTERING-ACTIVE SUBSTRATE

(71) Applicant: KING FAHD UNIVERSITY OF PETROLEUM AND MINERALS, Dhahran (SA)

(72) Inventor: Mohammad Kamal HOSSAIN, Dhahran (SA)

(73) Assignee: KING FAHD UNIVERSITY OF PETROLEUM AND MINERALS, Dhahran (SA)

(21) Appl. No.: 18/677,308

(22) Filed: May 29, 2024

(51) Int. Cl. G01N 21/65; B22F 1/054; B22F 1/18; C03C 17/00

(52) U.S. Cl. CPC G01N 21/658; B22F 1/054; B22F 1/18; C03C 17/007; C03C 17/008; B22F 2301/255; B22F 2302/25; B22F 2304/054; C03C 2218/11

(57) ABSTRACT

A surface-enhanced Raman scattering (SERS) substrate, containing a substrate, zinc oxide nanosheets (ZnO NSs), and gold nanoparticles, where the ZnO NSs have an average thickness of 40-70 nm, where the gold nanoparticles are embedded within the ZnO NSs to form a nanocomposite, and where the nanocomposite is dispersed on a surface of the substrate to form the SERS substrate.

### STATEMENT OF ACKNOWLEDGEMENT

Support provided by the King Fahd University of Petroleum and Minerals (KFUPM) is gratefully acknowledged.

### BACKGROUND

### Technical Field

The present disclosure is directed to a surface-enhanced Raman spectroscopy (SERS) substrate and, more particularly, to gold nanoparticles-embedded zinc oxide nanosheets on a SERS substrate.

### Description of Related Art

The “background” description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Raman spectroscopy is a well-established technique and is known for its non-destructive, reagent-free and rapid analysis advantages. Moreover, compared with traditional detection means such as electrochemical analysis, high-performance liquid chromatography, and gas chromatography-mass spectrometry, Raman spectroscopy is a popular candidate for real-time detection due to the fact that complex pretreatment on analytes is not needed, the analysis period is short, and the equipment manufacturing cost is low. However, its effective utilization is hindered due to the weak nature of Raman scattered light.

In Raman spectroscopy, the sample is illuminated with light, and a small portion of the photons will scatter at a different frequency than the incident light, called the Raman effect. These different frequency photons can give insight to vibrational energy modes of a sample, however due to the small portion of Raman scattering, the signal is inherently low. The signal of the detailed Raman fingerprints of target analytes can be increased using surface enhanced Raman scattering (SERS). In SERS, the sample is typically on a solid substrate in combination with noble metal particles. These noble metal particles help to enhance the SERS signal by absorbing light and generating a localized electromagnetic (EM) field. In SERS the intensities of normal peaks are several-fold improved with a short acquisition time by employing a nanostructured metal surface. For this reason, the development of new nanostructured metallic materials with tuned photoelectric properties can increase the efficacy of SERS sensing platforms.

Researchers have strived to improve substrate structure and maximize enhancement factors. Precious metal and semiconductor composite nanostructure SERS substrates have a good Raman enhancement effect but have drawbacks such as the preparation process is complicated and time-consuming, the uniformity and regularity of the morphology structure are poor, the large-area preparation is difficult, and the cost is difficult to effectively control.

Therefore, there exists a need to develop a SERS substrate which overcomes the aforementioned drawbacks. It is one object of the present disclosure to develop an easy-to-prepare and effective SERS substrate.

### SUMMARY

In an exemplary embodiment, a surface-enhanced Raman spectroscopy (SERS) substrate is described. The SERS substrate includes a substrate, zinc oxide nanosheets (ZnO NSs), and gold nanoparticles, where the ZnO NSs have an average thickness of 40-70 nm, and the gold nanoparticles are embedded within the ZnO NSs to form a nanocomposite, and the nanocomposite is dispersed on a surface of the substrate to form the SERS substrate.

In some embodiments, the ZnO NSs have a longest dimension of 0.5-2.0 μm.

In some embodiments, the ZnO in the ZnO NSs has a wurtzite crystal structure.

In some embodiments, gold is not doped within the crystal structure of the ZnO in the ZnO NSs.

In some embodiments, the gold nanoparticles contain only gold.

In some embodiments, the gold nanoparticles are crystalline.

In some embodiments, the gold nanoparticles are spherical and have an average diameter of 1-20 nm.

In some embodiments, the nanocomposite does not contain a capping agent or a surfactant.

In some embodiments, the nanocomposite is not aggregated on the surface of the substrate.

In some embodiments, the substrate is selected from the group consisting of glass, ITO (indium tin oxide), FTO (fluorine doped tin oxide) or AZO (aluminum-doped zinc oxide).

In an exemplary embodiment, a method of making the nanocomposite is described. The method includes adding a zinc salt in a solvent to form a first solution, adding hydrogen tetrachloroaurate in water to form a second solution, mixing the first solution and the second solution and heating for less than 1 hour to form a reaction solution, cooling the reaction solution to 5-10° C. in an absence of light for at least 24 hours to form the nanocomposite.

In some embodiments, the first solution has a concentration of 0.05-0.5 M of the zinc salt and the second solution has a concentration of 0.5-2 M of the hydrogen tetrachloroaurate.

In some embodiments, the reaction solution includes a same volume of each of the first solution and the second solution.

In an exemplary embodiment, a method of performing SERS is described. The method includes coating the SERS substrate with a Raman dye; and measuring a Raman signal of the Raman dye on the SERS substrate, where an intensity of the Raman signal of the Raman dye is higher than a Raman signal of the Raman dye measured by the same method but without the SERS substrate. In some embodiments, the method of measuring the Raman signal with the Raman dye includes irradiating with 600-700 nm light.

In some embodiments, the Raman signal is monitored from 200-1,800 cm⁻¹.

In some embodiments, the Raman dye is a rhodamine dye.

In some embodiments, the intensity of the Raman signal of the Raman dye is at least two times higher than the Raman signal of the Raman dye measured by the same method but without the SERS substrate.

The foregoing general description of the illustrative embodiments and the following detailed description are merely exemplary aspects of this disclosure's teachings and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart depicting a method of forming the nanocomposite, according to certain embodiments.

FIG. 2 is a schematic demonstrating the synthesis route to zinc oxide (ZnO NSs) and nanosheets and gold nanoparticles-embedded zinc oxide nanosheets (Au-NP@ZnO NSs) with inset (i) and inset (ii) showing field emission scanning electron microscope (FESEM) micrographs of Au-NP@ZnO NSs and ZnO NSs, respectively, according to certain embodiments.

FIG. 3A shows a Scanning Electron Microscopy (SEM) image of the ZnO NSs along with insets, according to certain embodiments.

FIG. 3B shows a high-resolution FESEM image of the ZnO NSs along with insets of the areas marked, according to certain embodiments.

FIG. 4A shows an SEM image of the Au-NP@ZnO NSs along with insets, according to certain embodiments.

FIG. 4B shows a high-resolution FESEM image of the Au-NP@ZnO NSs along with insets of areas marked, according to certain embodiments.

FIG. 5A shows a Transmission Electron Microscopy (TEM) image of the ZnO NSs along with insets, according to certain embodiments.

FIG. 5B shows a high-resolution TEM image of the ZnO NSs revealing localized fringes in different directions, along with insets, according to certain embodiments.

FIG. 5C shows a Selected Area Electron Diffraction (SAED) pattern of the ZnO NSs according to certain embodiments.

FIG. 6A shows a TEM image of Au-NP@ZnO NSs, according to certain embodiments.

FIG. 6B shows a high-resolution TEM image of a selected area marked by the white rectangle in FIG. 6A; inset: zoom-in view (50 nm×50 nm) indicating the existence of Au NPs, according to certain embodiments.

FIG. 6C shows a high-resolution TEM image of the Au-NP@ZnO NSs revealing localized fringes in different directions, with insets marked, according to certain embodiments.

FIG. 6D shows a SAED pattern of the Au-NP@ZnO NSs, according to certain embodiments.

FIG. 7A shows a SERS spectrum of the ZnO NSs adsorbed with Rhodamine 6G (R6G) dyes, according to certain embodiments.

FIG. 7B shows a Raman spectrum of the ZnO NSs, according to certain embodiments.

FIG. 7C shows a background signal of the ZnO NSs adsorbed with the R6G dyes, along with an inset (CCD image of the specimen), according to certain embodiments.

FIG. 7D shows a background signal of the ZnO NSs, along with an inset (CCD image of the specimen), according to certain embodiments.

FIG. 8A shows a SERS spectrum of the Au-NP@ZnO NSs adsorbed with R6G, according to certain embodiments.

FIG. 8B shows a Raman spectrum of the Au-NP@ZnO NSs, according to certain embodiments.

FIG. 8C shows a background signal of the Au-NP@ZnO NSs adsorbed with the R6G dyes, along with an inset (CCD image of the specimen), according to certain embodiments.

FIG. 8D shows a background signal of the Au-NP@ZnO NSs, along with an inset (CCD image of the specimen), according to certain embodiments.

FIG. 9A shows a Finite Difference Time Domain (FDTD) model indicating the dimension of the gold nano-objects and the ZnO NS, with inset (i) showing a YZ-plane view indicating nano-objects modeled along the center of the ZnO NS, according to certain embodiments.

FIG. 9B-FIG. 9D show electromagnetic (EM) near-field distributions (XY-plane) along the surface of the Au-NP@ZnO NSs for s-, p-, and 45° of incident polarizations, respectively, according to certain embodiments.

FIG. 9E-FIG. 9G show electromagnetic (EM) near-field distributions (XY-plane) along the center of the Au-NP@ZnO NSs for s-, p-, and 45° of incident polarizations, respectively, according to certain embodiments.

FIG. 10A shows a FDTD model indicating the dimension of the gold nano-objects and the ZnO NS, with inset (i) showing a YZ-plane view indicating nano-objects modeled touching the top surface of NS, according to certain embodiments.

FIG. 10B-FIG. 10C show EM near-field distributions (XY-plane) along the surface of Au-NP@ZnO NSs for s-, p- and 45° of incident polarizations, respectively, according to certain embodiments.

FIG. 10D-FIG. 10F show EM near-field distributions (XY-plane) along the center of the Au-NP@ZnO NSs for s-, p- and 45° of incident polarizations respectively, according to certain embodiments.

### DETAILED DESCRIPTION

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

As used herein, the term “Raman scattering” refers to inelastic scattering of a photon incident on a molecule, more particularly, to a process that produces light of frequency other than the frequency of the incident light.

As used herein, the term “Surface-enhanced Raman scattering” or “SERS” refers to a phenomenon that occurs when a Raman scattering signal, or intensity, is enhanced when a Raman-active molecule is adsorbed on or in close proximity to a metal surface.

As used herein, the terms “nanoparticle” and “NP” are used interchangeably and are intended to refer to a particle having at least one dimension in the range of about 1 nm to about 500 nm.

Unless otherwise noted, the present disclosure is intended to include all isotopes of the samples used herein.

Aspects of the present disclosure are directed to a surface-enhanced Raman spectroscopy (SERS) substrate, which includes a nanocomposite of zinc oxide nanoparticles and gold nanoparticles dispersed on a substrate. The presence of gold nanoparticles in the nanocomposite provides an enhanced Raman signal of a molecule on the SERS substrate.

In an exemplary embodiment, a SERS substrate is described. The SERS substrate includes a substrate, zinc oxide nanoparticles, and gold nanoparticles. The choice of the substrate is not limited to glass, sapphire, diamond, silicon, geranium, a binary semiconductor such as gallium arsenide, zinc sulfide, and cadmium selenide, a metal such as titanium, nickel, chromium, aluminum, and copper, and mixtures thereof. In a preferred embodiment, the substrate is a glass substrate. The glass substrate is at least one selected from the group consisting of a fluorine-doped tin oxide (FTO) coated glass substrate, a tin-doped indium oxide (ITO) coated glass substrate, an aluminum doped zinc oxide (AZO) coated glass substrate, a niobium doped titanium dioxide (NTO) coated glass substrate, an indium doped cadmium oxide (ICO) coated glass substrate, an indium doped zinc oxide (IZO) coated glass substrate, a fluorine-doped zinc oxide (FZO) coated glass substrate, a gallium doped zinc oxide (GZO) coated glass substrate, an antimony doped tin oxide (ATO) coated glass substrate, a phosphorus-doped tin oxide (PTO) coated glass substrate, a zinc antimonate coated glass substrate, a zinc oxide coated glass substrate, a ruthenium oxide coated glass substrate, a rhenium oxide coated glass substrate, a silver oxide coated glass substrate, and a nickel oxide coated glass substrate. In a preferred embodiment, the substrate is selected from the group consisting of plain glass, FTO, ITO, and AZO.

In certain embodiments, the substrate may have a thickness of less than or equal to about 3 mm, for example, ranging from about 0.1 mm to about 2.5 mm, from about 0.3 mm to about 2 mm, from about 0.7 mm to about 1.5 mm, or from about 1 mm to about 1.2 mm, including all ranges and subranges therebetween.

The nanocomposite of zinc oxide nanoparticles and gold nanoparticles is dispersed on the surface of the substrate to form the SERS substrate. In some embodiments, the nanocomposite covers at least 50%, preferably 55%, preferably 60%, preferably 65%, preferably 70%, preferably 75%, preferably 80%, preferably 85%, preferably 90%, preferably >95% of the substrate.

In a preferred embodiment, the nanocomposite is immobilized on the substrate by adsorption. The exact nature of the bonding depends on the details of the species involved but the process can generally be classified as physisorption (characteristic of weak van der Waals forces), chemisorption (characteristic of covalent bonding), or due to electrostatic attraction. As used herein, “immobilized”, “immobilizing”, “adsorbed”, “adsorbing”, “bound,” or “binding” refers to the adsorption and/or chemical binding via strong atomic bonds (e.g., ionic, metallic and covalent bonds) and/or weak bonds such as van der Waals, hydrogen. In a preferred embodiment, the gold nanoparticles are physisorbed onto the substrate, leaving the chemical species of both materials intact. In a preferred embodiment, when depositing the nanocomposite on the substrate the surface tension is carefully controlled in order to prevent aggregation and heterogeneity. In some embodiments, the nanocomposite is not aggregated on the surface of the substrate and is homogeneously dispersed on the substrate.

In a preferred embodiment, the SERS substrate is substantially free of surfactants, capping reagents, and/or linkers that are often used to aid the immobilization of nanocomposites to the SERS substrates. Generally, surfactants, capping reagents, and/or linkers induce a background emission, which is unfavorable for the specific detection of analytes.

The zinc oxide (ZnO) is in a form of a nanoparticles. In general, the nanoparticles can be any shape known to one of ordinary skill in the art. Examples of suitable shapes the nanoparticles may take include spheres, spheroids, lentoids, ovoids, solid polyhedra such as tetrahedra, cubes, octahedra, icosahedra, dodecahedra, hollow polyhedral (also known as nanocages), stellated polyhedral (both regular and irregular, also known as nanostars), triangular prisms (also known as nanotriangles), hollow spherical shells (also known as nanoshells), tubes (also known as nanotubes), nanosheets, nanoplates, nanodisks, rods (also known as nanorods), and mixtures thereof. In some embodiments, the nanoparticles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of nanoparticles having a different shape. As used herein, the term “non-uniform shape” refers to an average consistent shape that differs by more than 10% of the distribution of nanoparticles having a different shape. In a preferred embodiment, the nanoparticles are in the form of nanosheets (NSs).

The ZnO NSs have an average thickness of 40-70 nm, preferably 45-65 nm, or 50-60 nm. The ZnO NSs have a longest dimension of 0.5-2.0 μm, or preferably 0.75-1.75 μm, or preferably 1-1.5 μm. The zinc oxide in the ZnO NSs may be any suitable phase of zinc oxide, such as sphalerite (cubic), matraite (trigonal), or wurtzite (hexagonal). In preferred embodiments, the zinc oxide is wurtzite zinc oxide/wurtzite crystal structure.

In some embodiments, the nanocomposite may include an additional transition metal oxide, in addition to the ZnO NSs. Examples of these include, but are not limited to, titanium dioxide, copper oxide (both CuO and Cu₂O), tin dioxide, iron (II) oxide, nickel oxide, and mixtures thereof. Further, as used herein, transition metal oxide also refers to materials that comprise both a transition metal and oxygen and which further comprise non-transition metals, such as alkaline earth metals or alkali metals. Examples of such materials include, but are not limited to, barium titanate, strontium titanate, lithium niobate, lanthanum calcium manganite, and mixtures thereof. In a preferred embodiment, the nanocomposite includes only zinc oxide nanoparticles, preferably ZnO NSs.

The nanocomposite further includes gold nanoparticles. In a preferred embodiment, the gold nanoparticles of the present disclosure substantially comprise elemental gold. The term “gold nanoparticle” as used herein refers to an elemental gold-rich material (i.e. greater than 50%, more preferably greater than 60%, more preferably greater than 70%, more preferably greater than 75%, more preferably greater than 80%, more preferably greater than 85%, more preferably greater than 90%, more preferably greater than 95%, most preferably greater than 99% elemental gold by weight).

In addition to elemental gold, various non-elemental gold materials including, but not limited to, gold alloys, metals, and non-metals, may be present in the gold nanoparticle. The total weight of these non-elemental gold materials relative to the total weight percentage of the gold nanoparticles is typically less than 30%, preferably less than 20%, preferably less than 15%, preferably less than 10%, more preferably less than 5%, more preferably less than 4%, more preferably less than 3%, more preferably less than 2%, more preferably less than 1%.

In addition to elemental gold, it is envisaged that the present disclosure may be adapted to incorporate gold alloys as gold nanoparticles. Exemplary gold alloys include but are not limited to, alloys with copper and silver (colored gold, crown gold, electrum), alloys with rhodium (rhodite), alloys with copper (rose gold, tumbaga), alloys with nickel and palladium (white gold) as well as alloys including the addition of platinum, manganese, aluminum, iron, indium and other appropriate elements or mixtures thereof. In one embodiment, it is envisaged that the present disclosure may be adapted in such a manner that the gold nanoparticles substantially comprise only gold. In a preferred embodiment, the gold nanoparticles are crystalline. In a preferred embodiment, the gold nanoparticles have a face-centered cubic crystal structure.

In one embodiment, the gold nanoparticles of the present disclosure are envisaged to be synthesized and formed into a variety of morphologies including, but not limited to, nanosheets, nanoplatelets, nanocrystals, nanospheres, nanorectangles, nanotriangles, nanopentagons, nanohexagons, nanoprisms, nanodisks, nanocubes, nanowires, nanofibers, nanoribbons, nanorods, nanotubes, nanocylinders, nanogranules, nanowhiskers, nanoflakes, nanofoils, nanopowders, nanoboxes, nanostars, tetrapods, nanobelts, nanourchins, nanoflowers, etc. and mixtures thereof. In some embodiments, the gold nanoparticles are spherical and have an average diameter of 1-20 nm, or preferably 5-15 nm, or preferably 10 nm.

In some embodiments, gold is not doped within the crystal structure of the ZnO in the ZnO nanoparticles. In a preferred embodiment, the gold nanoparticles and the ZnO nanoparticles remain as distinct materials in the nanocomposite. In some embodiments, the gold nanoparticles are embedded within the ZnO NSs to form the nanocomposite. In other words, the gold nanoparticles are dispersed inside of the nanosheets. In some embodiments, the gold nanoparticles are uniformly dispersed in the nanosheets. In some embodiments, the gold nanoparticles are centered inside of the nanosheets, or more preferably the gold nanoparticles touch a top of the nanosheets.

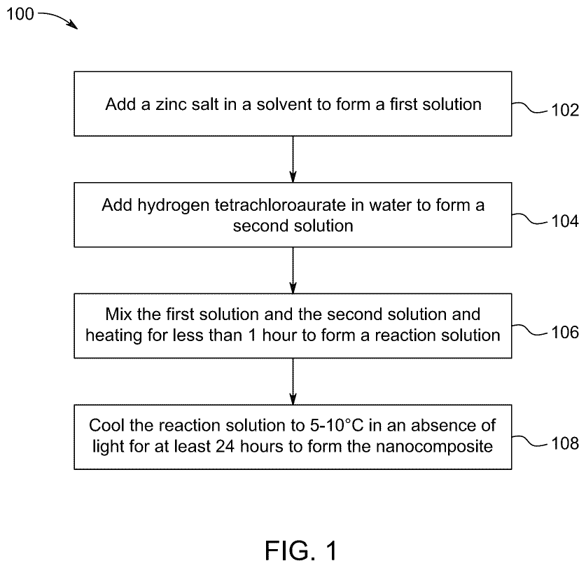

FIG. 1 illustrates a flow chart of a method 100 of making the nanocomposite. The order in which the method 100 is described is not intended to be construed as a limitation, and any number of the described method steps can be combined in any order to implement the method 100. Additionally, individual steps may be removed or skipped from the method 100 without departing from the spirit and scope of the present disclosure.

At step 102, the method 100 includes adding a zinc salt in a solvent to form a first solution. Suitable examples of zinc salts include, but are not limited to, zinc chloride, zinc gluconate, zinc sulfide, zinc pyrophosphate, zinc sulfate, zinc nitrate, zinc carbonate, zinc acetate, zinc citrate, zinc lactate, and or combinations and hydrates thereof. In a preferred embodiment, the zinc salt is zinc acetate. The zinc acetate may be anhydrous/hydrated. The zinc salt is dissolved in a suitable solvent, preferably water or alcohol. In a preferred embodiment, the solvent is an alcohol, preferably ethanol. The molar concentration of zinc acetate in the first solution is in the range of 0.05-0.5 M, more preferably 0.1-0.4 M, and yet more preferably 0.2-0.3 M. The first solution may be heated, preferably via reflux, to ensure complete dissolution of the zinc salt in the solvent.

At step 104, the method 100 includes adding hydrogen tetrachloroaurate of chloroauric acid in water to form a second solution. The concentration of hydrogen tetrachloroaurate in the second solution is in the range of 0.5-2 M, more preferably 0.75-1.5 M, and yet more preferably 1-1.25 M. The hydrogen tetrachloroaurate is dissolved in a suitable solvent, preferably water or alcohol.

At step 106, the method 100 includes mixing the first solution and the second solution and heating for less than 1 hour to form a reaction solution, preferably 45 minutes, 30 minutes or 10 minutes. In a preferred embodiment, a volume ratio of the first solution and the second solution is 1:5 to 5:1, preferably 1:4 to 4:1, preferably 1:3 to 3:1, preferably 1:2 to 2:1, preferably 1:1.

At step 108, method 100 includes cooling the reaction solution to 5-10° C., preferably 6-9° C., preferably around 8° C., in the absence of light for at least 24 hours, preferably 30 hours, 35 hours, 40 hours, or 48 hours to form the nanocomposite. It is preferred to carry out the reaction in the dark, at low temperatures, to minimize other unwanted side-products from the higher energy supplied (from light energy or heat)-to yield the nanocomposite.

A method of performing SERS using the SERS substrate is also described. The method includes coating the SERS substrate with a Raman dye. In the context of Raman spectroscopy, a Raman dye is a molecule that exhibits Raman scattering, meaning it can produce intense and characteristic Raman signals when illuminated with laser light. In other words, the coating enhances Raman signals through the SERS effect. Suitable examples of the Raman dye include, but are not limited to, cyanine-3, cyanine-5, cyanine-5.5, cyanine 7, 4-aminothiophenol, 4-methylbenzenethiol, 2-naphthalenethiol, 2-naphthalenethiol, rhodamine-5-(and-6)-isothiocyanate, tetramethylrhodamine-5-isothiocyanate, rhodamine b, Rhodamine 6G, nile blue, fam, and Tamra. In a preferred embodiment, the Raman dye is a Rhodamine dye. In some embodiments, the Raman dye is coated via spin coating. Other examples of coating not described herein are contemplated. For example, the coating of Raman dye may be applied through dip coating or spray coating.

The method further includes measuring the Raman signal of the Raman dye on the SERS substrate. The step of measuring the Raman signal involves irradiating light of a wavelength in the range of 600-700 nm, preferably 610-690 nm, preferably 620-680 nm, preferably 630-670 nm, preferably 645-660 nm, and further monitoring the Raman signal from 200-1,800 cm⁻¹, preferably 300-1,700 cm⁻¹, or preferably 400-1,600 cm⁻¹, or preferably the 500-1,500 cm⁻¹, or preferably 600-1,400 cm⁻¹, or preferably 700-1,300 cm⁻¹, or preferably 800-1,200 cm⁻¹, or preferably 900-1,100 cm⁻¹. In some embodiments, the frequency of light irradiated/monitored may vary based on the Raman dye coated on the substrate.

The intensity of the Raman signal of the Raman dye is higher than the intensity of the Raman signal of the Raman dye measured by the same method but without the SERS substrate. In some embodiments, the intensity of the Raman signal of the Raman dye is at least two times higher, preferably three times, four times, five times, six times, seven times, eight times, nine times, or ten times than the Raman signal of the Raman dye measured by the same method but without the SERS substrate.

### EXAMPLES

The following examples demonstrate a surface-enhanced Raman scattering (SERS) substrate, as described herein. The examples are provided solely for illustration and are not to be construed as limitations of the present disclosure, as many variations thereof are possible without departing from the spirit and scope of the present disclosure.

### Example 1: Materials

Hydrogen tetrachloroaurate (HAuCl₄.3H₂O), Zinc acetate (Zn(CH₃COO)₂·2H₂O), and ethanol (CH₂CHOH) were purchased from Sigma-Aldrich and used as received without any further modification. Rhodamine 6G (R6G) from Chroma GesellschaftSchmid GMBH & Co.) was used as received without any further purification.

### Example 2: Synthesis of Nanosheets and Nanocomposite

Zinc oxide (ZnO) precursor was prepared. In brief, a 100 ml ZnO solution of 0.1 M was prepared by dissolving zinc acetate in ethanol and refluxing for 1 h at room temperature on a magnetic stirrer. The Au precursor was prepared. In brief, a 50 ml Au solution of 1 mM was prepared by dissolving hydrogen tetrachloroaurate in deionized water. Subsequently, 50 ml of Au precursor was added to 50 ml of ZnO precursor dropwise, and the refluxing continued for another 30 minutes at room temperature on a magnetic stirrer. This method was used to prepare ZnO alone and with the Au. For the ZnO alone, the Au precursor solution was not added to the ZnO precursor.

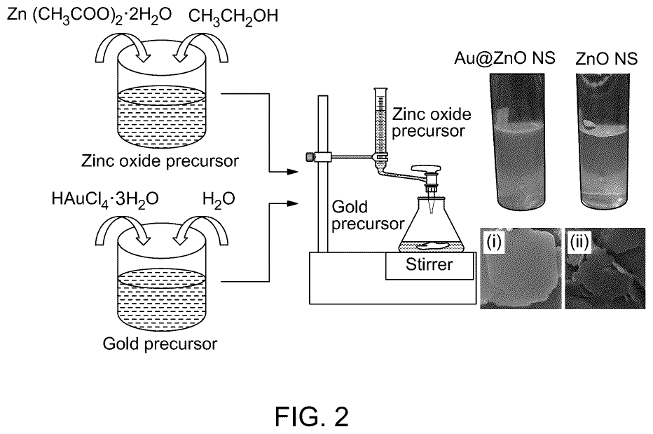

Both solutions, ZnO precursor mixed with Au precursor and ZnO precursor alone, were transferred immediately to a chemical storage system with a temperature of ˜8° C. in a dark environment. After 72 hours, ZnO precursor mixed with Au solutions (called hereafter Au-NPs embedded in ZnO NSs or Au-NP@ZnO NSs) and ZnO precursor only (called hereafter zinc oxide nanosheets (ZnO NSs)) were found to be light orange and semitransparent respectively. The method of preparation of the Au-NP@ZnO NSs is depicted in FIG. 2.

### Example 3: Characterization Techniques

Topographic confirmation was carried out with the aid of a Field Emission Scanning Electron Microscope (FESEM), as shown in the inset of FIG. 2. Inset (i) and inset (ii) of FIG. 2 displays individual FESEM micrographs of the Au-NPs@ZnO NSs and ZnO NSs, respectively. Transmission Electron Microscopy (TEM) and high-resolution TEM (HRTEM) investigations were carried out. Selected area electron diffraction (SAED) patterns and high-resolution TEM confirmed the existence of Au NPs embedded in the ZnO NSs.

A fully integrated confocal Raman microscope, the LabRam HR Evolution Raman spectrometer from Horiba, was used to validate the SERS-activity of the as-synthesized specimen. All the measurements were carried out in the range of 200 to 1800 cm⁻¹ at room temperature under ambient conditions. In brief, an excitation source, a He-Ne laser (632.8 nm with 17 mW base power), was focused on the sample surface through a long working distance lens (50×). The Raman spectrometer was set up as an illumination-backscattering configuration. The laser was focused at the site of interest through an objective lens, and the Raman scattering signal from the same spot was collected through the same lens and processed by the optical analyzer. Throughout the measurements, the laser exposure time and accumulation time were maintained at 10 seconds and 2 seconds, respectively. The laser intensity was adjusted to 25% to avoid any possibility of dissociation of dyes or damage to the sample surface, and the dye was turned off immediately after the measurement.

### Example 4: SERS Substrate Preparation

Special care was taken to prepare SERS-active substrates using as-synthesized nanomaterials. Aggregation of nanomaterials is a common concern and therefore, capping agents or surfactants are used to get self-assembled nanostructures. However, capping agents or surfactants are responsible for inducing unwanted background as well as inhibiting the target analyte from being at the hot spot; a site of intense Raman signal. In this study, the SERS-active substrate was prepared as follows. In brief, an aliquot of ZnO NSs solution and Au-NPs@ZnO NSs solution dropped on a microscopic glass slide and the surface tension of the droplet was controlled. A standard Raman-active dye, Rhodamine 6G (R6G from Chroma GesellschaftSchmid GMBH & Co.) was used as received without any further purification. As-fabricated substrates of ZnO NSs and Au-NPs@ZnO NSs were incubated with R6G dye of 1×10⁻⁶ M for 10 min. Before the measurements, the samples were copiously washed with DI water and measurements were repeated several times at a specific site of interest.

### Example 5: Calculations Procedure

An FDTD model was developed to demonstrate the effect of Au-NPs@ZnO NSs on electromagnetic (EM) field distributions and, subsequently, the enhanced Raman signal of the target analyte in the presence of such Au-NPs@ZnO NSs. Nanoparticles embedded in nanosheets similar to those observed in TEM investigations were developed and simulated by Planc FDTD (ver. 6.2). EM near-field distributions along various planes for s-, p-, and 45° of incident polarizations were extracted and analyzed to correlate with those obtained in near-field SERS observations. In order to correlate the EM near-field distribution, a 632.8 nm excitation that is normal to the model geometries was utilized in the FDTD simulation. Au nano-objects were assumed to be smooth, spherical, and equally separated, despite the fact that the individual nanoparticles differed from one another, notably in size and distribution, as seen in topographical studies. Two specific scenarios, such as Au nanoparticles array embedded along the center of the nanosheet and those just touching the top surface of the ZnO NSs, were modeled and simulated.

### Example 6: Characterization

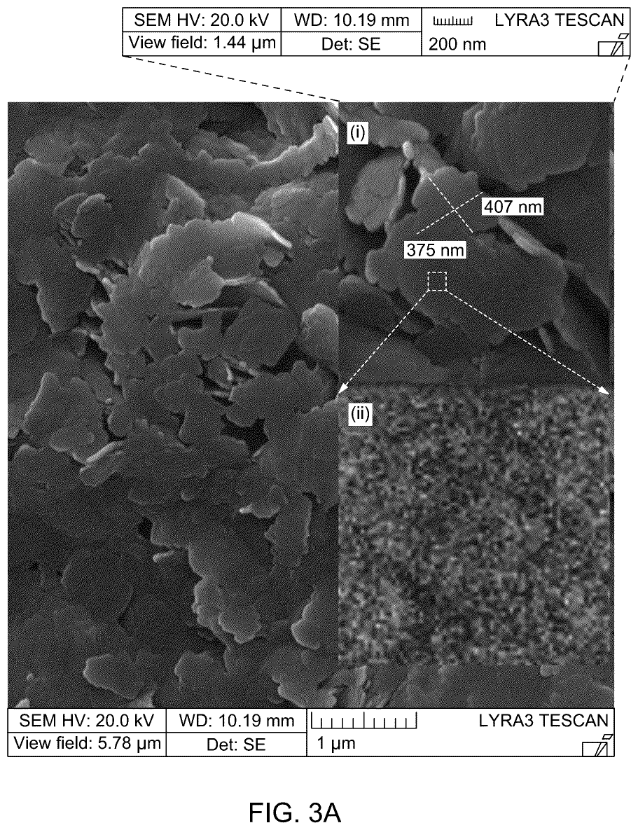

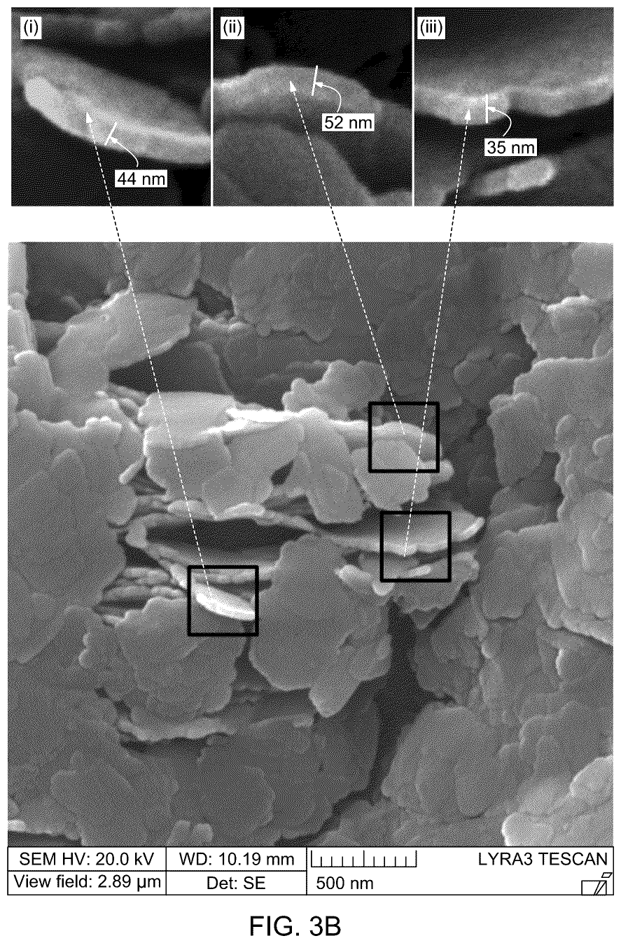

A series of high-resolution SEM and high-resolution TEM experiments were carried out. FIG. 3 shows SEM micrographs of as-synthesized ZnO NSs. Maple leaf-like ZnO NSs of different dimensions were observed, as shown in FIG. 3A. A coverage of ˜9×10^{10/}cm² was estimated in this context. A high-resolution FESEM image of the same is shown in inset (i) of FIG. 3A. Inset (i) of FIG. 3A represents several individual ZnO NSs. Dimensions across two directions of ZnO NSs have been estimated to be 375 and 407 nm, as shown in the inset (i) of FIG. 3A. A zoom-in view of a small area (100 nm×100 nm) as marked by the black dotted square in inset (i) of FIG. 3A was shown in inset (ii) of FIG. 3A. The resolution of FESEM was not high enough to reveal further detail, although there was no indication of irregularities on the surface of ZnO NSs. A high-resolution FESEM image of ZnO NSs is shown in FIG. 3B, along with three sites of interest, to elucidate the possible thickness of as-synthesized ZnO NSs. Insets (i)-(iii) of FIG. 3B displays zoon-in views of individual ZnO NSs corresponding to three sites (300 nm×300 nm) as marked by the black squares in FIG. 3B. Estimated thicknesses of 35, 44, and 52 nm, as indicated in the insets, were observed in this regard. To this extent, the edges of such ZnO NSs were observed to be irregular and rough.

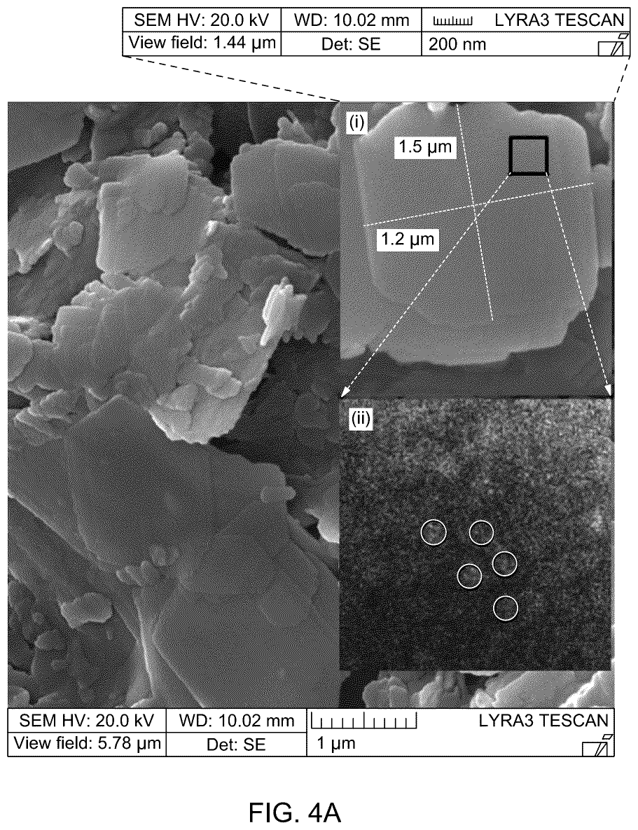

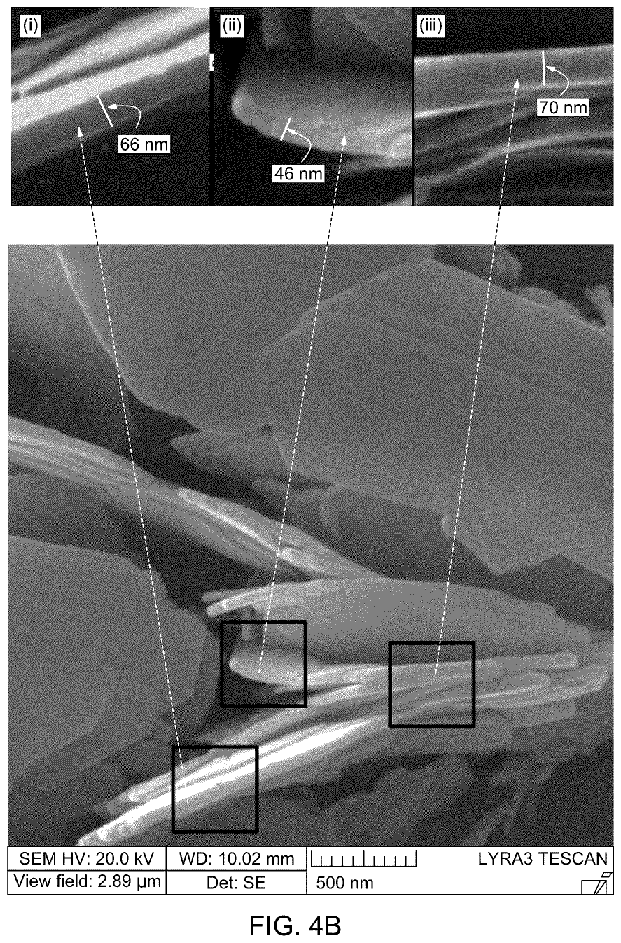

In the presence of Au precursor, ZnO precursor was affected and turned orange in color, as shown in FIG. 2. FIG. 4A shows SEM micrographs of as-synthesized Au-NPs@ZnO NSs. Maple leaf-like ZnO NSs were found to reshape to be more regular and smoother-edged. Au-NPs@ZnO NSs were observed to be of different shapes and sizes. FIG. 4A represents a SEM micrograph of the same with an estimated coverage of ˜32×10⁹/cm². A high-resolution FESEM image of the same is shown in inset (i) of FIG. 4A. Inset (i) of FIG. 4A represents an individual Au-NPs@ZnO NSs. With reference to that of ZnO NSs, the Au-NPs@ZnO NSs were found to be several times larger. Dimensions across two directions of the same Au-NPs@ZnO NSs have been estimated to be 1.2 and 1.15 μm, as shown in the inset (i). A zoom-in view of a small area (200 nm×200 nm), as marked by the black square in inset (i) of FIG. 4A was shown in inset (ii) of FIG. 4A. Interestingly, it was noticed that the surface of the Au-NPs@ZnO NSs indicated the existence of tiny structures. FIG. 4B displays a high-resolution FESEM image of Au-NPs@ZnO NSs. In order to find out the average thickness of Au-NPs@ZnO NSs, three sites of interest were marked by the black squares in FIG. 4B were analyzed and shown in insets (i)-(iii) in the FIG. 4B. Insets (i)-(iii) of FIG. 4B represents zoom-in views of the abovementioned three sites (400 nm×400 nm) as marked by the black squares in FIG. 4B. Estimated thicknesses of 66, 46, and 70 nm, as indicated in the insets, were observed in this regard. With reference to ZnO NSs, the thickness of Au-NPs@ZnO NSs was higher in addition to smoother and more regular edges.

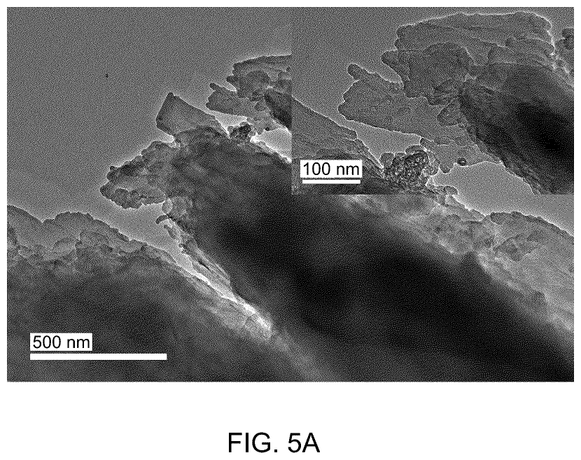

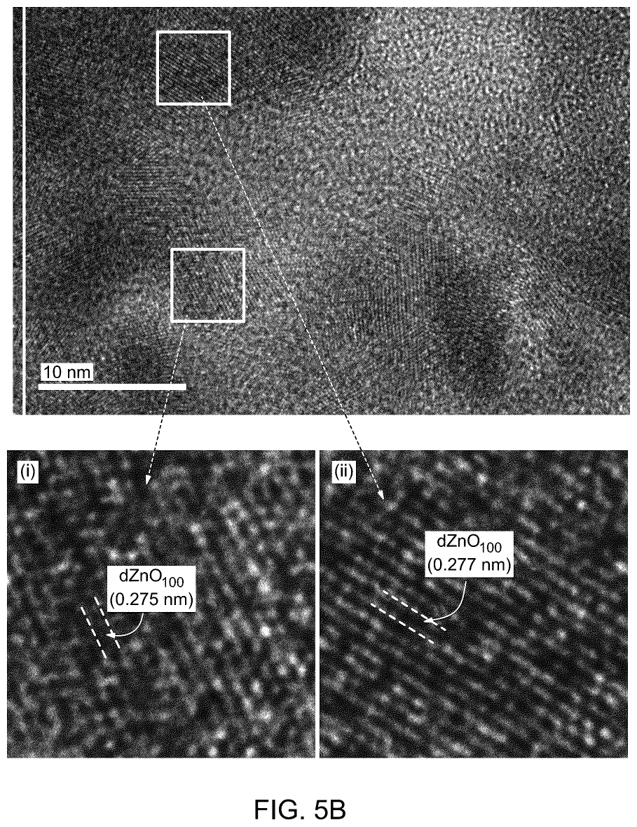

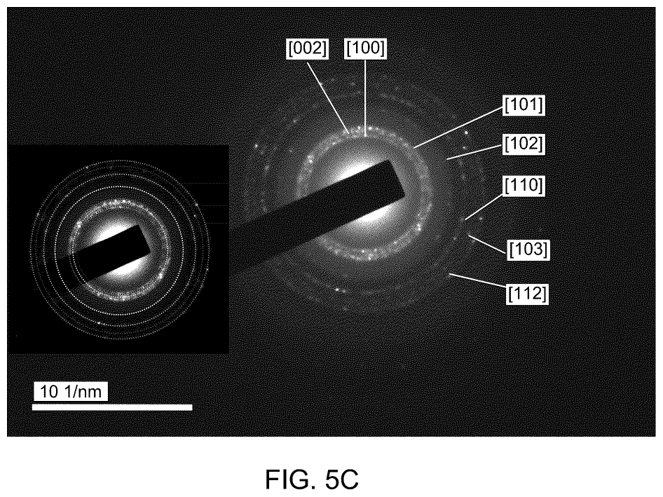

A TEM investigation was performed to understand the nanoscale structures. FIG. 5A is a TEM micrograph of ZnO NSs. The inset of FIG. 5A represents a high-resolution TEM of the same. A segment of such ZnO NSs was further investigated through high-resolution TEM measurements, as shown in FIG. 5B. FIG. 5B displays a small section (40 nm×30 nm) of a high-resolution TEM consisting of numerous nanocrystallites of different sizes. Two sites as marked by the white squares (5 nm×5 nm) in FIG. 5B were zoomed in and shown in inset (i) and inset (ii) of FIG. 5B. The insets depict two lattice fringe spacings of 0.275 and 0.277 nm, as mentioned in the insets therein. Interestingly, it was noteworthy to mention that interplanar spacings deduced from the abovementioned fringes coincided well with the spacing of {100} planes in the wurtzite structure of ZnO as per the database of JCPDS 36-1451.

FIG. 5C shows a SAED pattern recorded at ZnO NSs, along with bright spots therein. The crystallinity of ZnO NSs was confirmed by the bright diffraction spots, as observed in FIG. 5C. To the extent that these spots were found to be arranged in rings, as mentioned in the inset of FIG. 5C.

The inset of FIG. 5C represents a filtered SAED pattern of the same, along with rings indicating the presence of well-defined nanocrystallites in ZnO NSs. As mentioned in the inset of FIG. 5C, the concentric rings in the zero-order Laue zone were produced and overlapped with the SAED bright spots considering a continuous angular distribution of (hkl) spots at a distance of 1/dₕₖₗ from the (000) spot. The radius of the ring r(hkl) and the interplanar lattice spacing d(hkl) are related by eq. 1 below.

$$r ( hlk ) \times {d}_{hkl} = L λ \qquad ( eq . 1 )$$

where Lλ=1 is the camera constant of the TEM.

From the SAED pattern, radii were estimated and lattice spacings were calculated according to eq. 1. The d-values estimated from the experimental SAED pattern were found to be 2.778, 2.5904, 2.4722, 1.9011, 1.5974, 1.4815 and 1.3550 Å corresponding to the planes {100}, {002}, {101}, {102}, {110}, {103}, and {200} respectively. These values coincided well with the wurtzite phase of ZnO (JCPDS 36-1451) with space group P63mc.

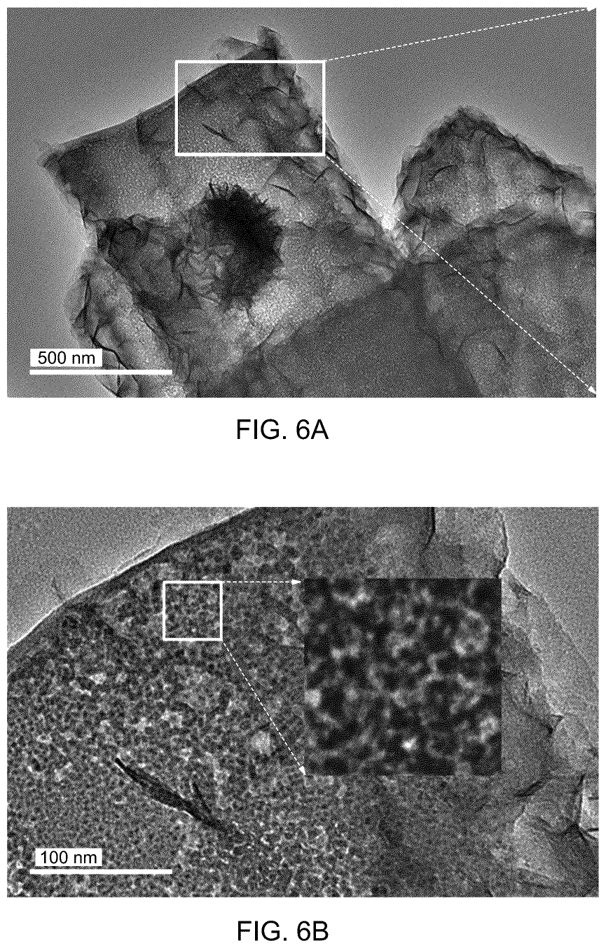

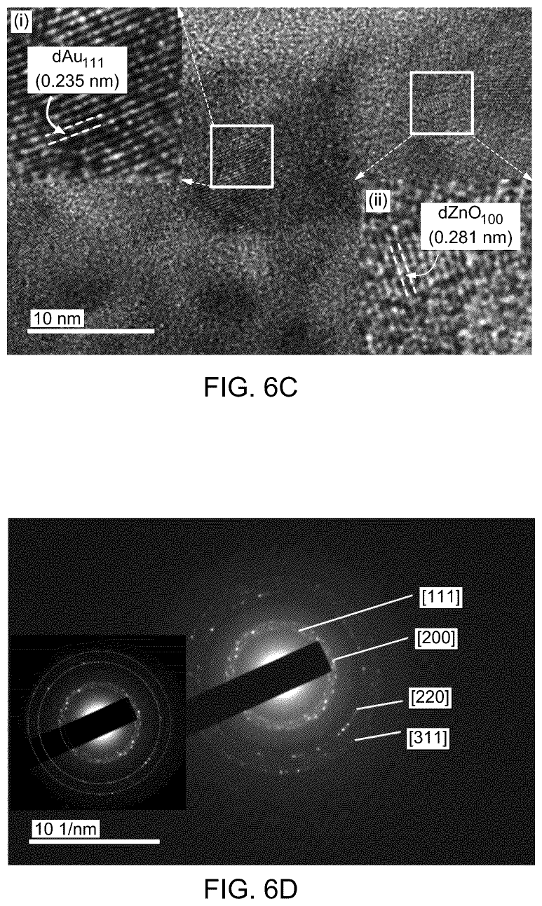

FIG. 6A is a TEM micrograph of Au-NPs@ZnO NSs. A high-resolution TEM revealed the existence of Au NP embedded within the ZnO NSs, as shown in FIG. 6B. FIG. 6B represents a high-resolution TEM micrograph indicating the existence of Au NP within the ZnO NSs, as shown in the inset of FIG. 6B. A zoom-in view of a small area marked by the white square (50 nm×50 nm) in FIG. 6B has been shown in the inset of FIG. 6B. A segment of such Au-NPs@ZnO NSs was further investigated through high-resolution TEM measurements, as shown in FIG. 6C. FIG. 6C displays a small segment (40 nm×30 nm) of a high-resolution TEM consisting of numerous nanocrystallites of different sizes. Interestingly, the fringes confirmed the coexistence of Au and ZnO nanocrystals. Two sites, as marked by the white squares (5 nm×5 nm) in FIG. 6C were zoomed in and shown in inset (i) and inset (ii) of FIG. 6C. The insets (i)-(ii) depict two lattice fringe spacings of 0.235 and 0.281 nm, respectively, as mentioned in the insets therein. Interestingly, it was noteworthy to mention that the interplanar spacing deduced in inset (i) coincided well with the spacing of {111} planes of Au as per the database of JCPDS 04-0784. On the other hand, the interplanar spacing deduced in inset (ii) coincided well with the spacing of {100} planes in the wurtzite structure of ZnO as per the database of JCPDS 36-1451.

FIG. 6D shows a SAED pattern recorded at Au-NPs@ZnO NSs, along with bright spots therein. The crystallinity of Au-NPs@ZnO NSs was confirmed by the bright diffraction spots, as observed in FIG. 6D. To the extent that these spots were found to be arranged in rings as mentioned in the inset of FIG. 6D. The inset of FIG. 6D represents a filtered SAED pattern of the same, along with rings indicating the presence of well-defined nanocrystals in Au-NPs@ZnO NSs. As mentioned in the inset of FIG. 6D, the concentric rings in the zero-order Laue zone (ZOLZ) were produced and overlapped with the SAED bright spots considering a continuous angular distribution of (hkl) spots at a distance of 1/dₕₖₗ from the (000) spot. From the SAED pattern, radii were estimated, and lattice spacings were calculated according to eq. 1. The d-values estimated from the experimental SAED pattern were 2.7210, 2.4096, 2.5885, and 1.3486 Å corresponding to the planes {111}, {200}, {220} and {311} respectively. These values coincided well with crystalline Au (JCPDS 04-0784).

### Example 7: SERS Measurements

In SERS measurements, two enhancement mechanisms, chemical enhancement (CE mechanism) and electromagnetic enhancement (EM mechanism), are considered to be the main reasons behind the enhancement in the Raman scattering process. Noble metal NPs, particularly Au NPs are known to enhance SERS-active electrodes through the EM mechanism.

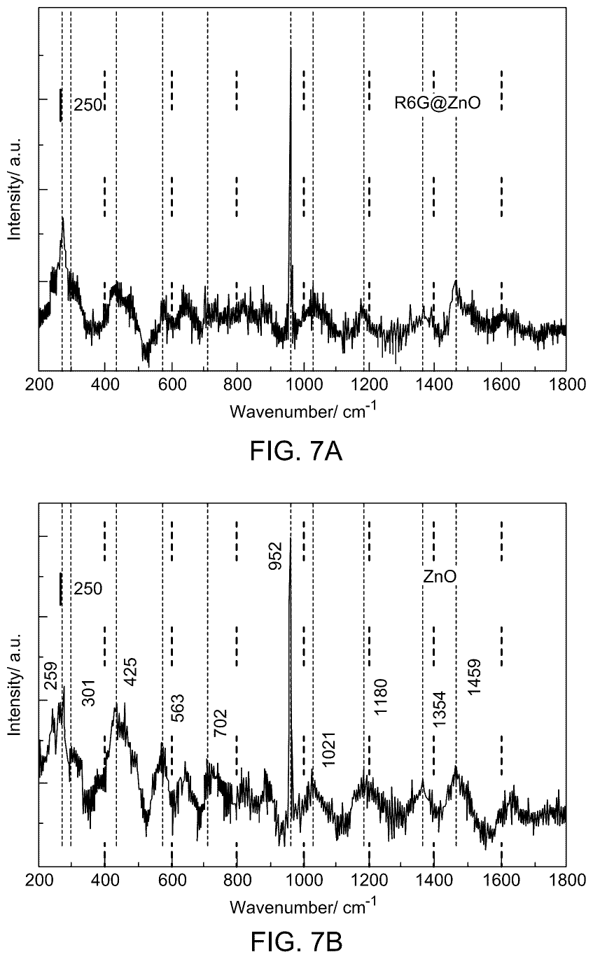

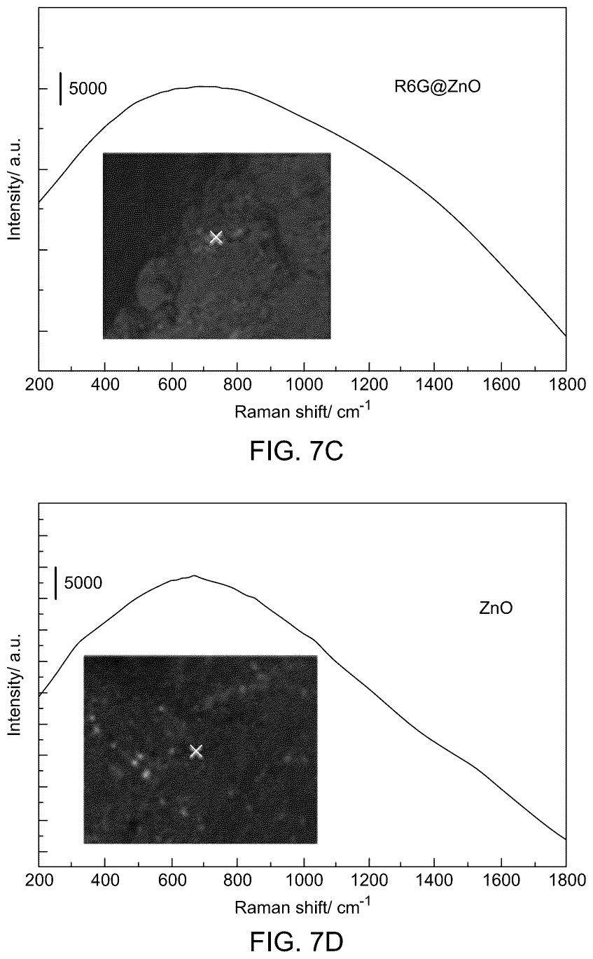

In this investigation, ZnO NSs and Au-NPs@ZnO NSs were investigated and used as SERS-active electrodes in Raman active molecule detection. FIG. 7A shows the SERS spectra of R6G adsorbed on ZnO NSs excited by 632.8 nm. Interestingly, no SERS band of R6G was observed in this context. As a reference, the Raman spectrum of ZnO NSs without any R6G was recorded as shown in FIG. 7B. Several Raman bands of ZnO, as indicated in FIG. 7B were observed.

According to the group theory, wurtzite ZnO exhibits optical modes as per following equation 2 below.

$${Γ}_{opt} = {A}_{1} + 2 {B}_{1} + {E}_{1} + 2 {E}_{2} \qquad ( eq . 2 )$$

Where A₁, E₁, and E₂ are Raman active, and B₁ is inactive in Raman (known as silent modes).

Vertical solid lines in FIG. 7A and FIG. 7B, were inserted to show Raman bands obtained in both cases. Raman bands observed are tabulated in Table 1, along with corresponding band assignments. It was noteworthy that the SERS spectrum of R6G on ZnO NSs and the Raman spectrum of ZnO NSs only obtained at 632.8 nm excitation has a strong fluorescence background, as shown in FIG. 7C and FIG. 7D, respectively. Insets of FIG. 7C and FIG. 7D represents CCD images of the same specimens along with the focused spot marked by a white “x” used to obtain the SERS and Raman spectra. No damage or dissociation of R6G dyes was noticed due to the very low intensity and exposure to laser excitation. As mentioned in the experimental section, the laser was cut off at 25% in intensity and turned off immediately after the measurement without changing the focusing spot on the same specimen.

TABLE 1
Raman modes recorded for ZnO NSs and
corresponding band assignments.

| Mode of Vibration | Raman Shift/cm⁻¹ |
|---|---|
| C—O Stretch mode | 1459 |
| CH₃ bending mode | 1354 |
| A₁(TO) + E1 (TO) + E_{2L} mode | 1180 |
| Two photon mode | 1021 |
| A₁(TO) + E1 (LO) mode | 952 |
| Acetate group O—C—O symmetric bending mode | 702 |
| B₁ (high) Raman mode | 563 |
| E₂ (high) Raman mode | 425 |
| Second-order Raman mode | 301 |
| B₁ (low) Raman mode | 259 |

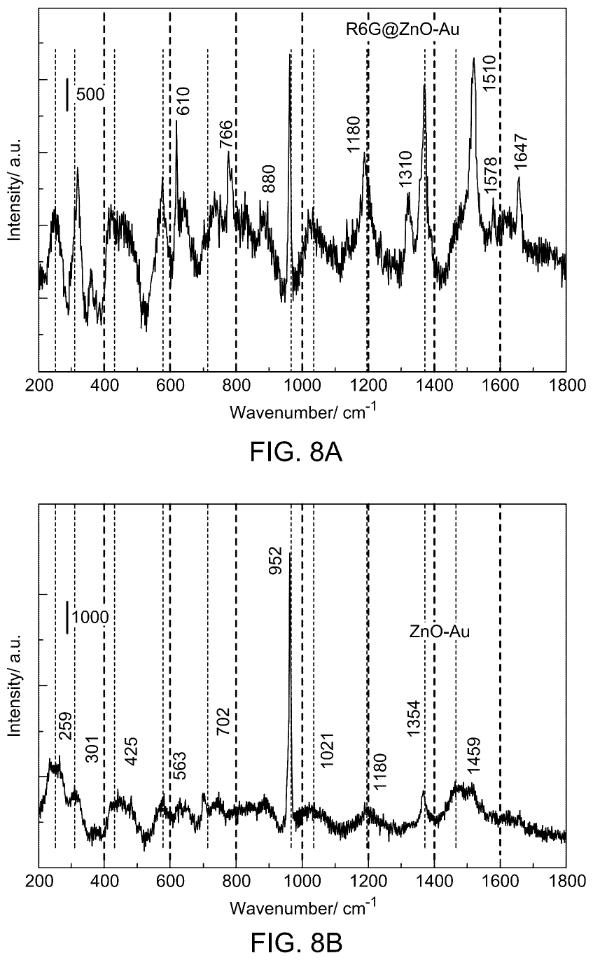

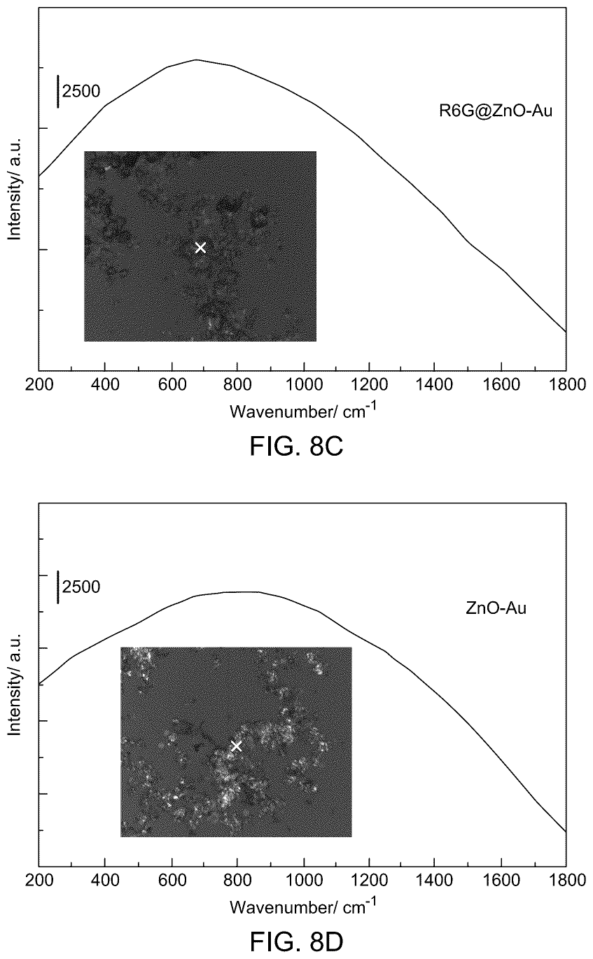

As demonstrated in FIG. 6A, high-resolution TEM confirmed the existence of Au NP within the matrix of ZnO NSs. Therefore, such Au NP embedded in ZnO NSs should contribute to the SERS enhancement of R6G. Indeed, a strong enhancement in SERS was observed at Au-NPs@ZnO NSs. FIG. 8A shows the SERS spectra of R6G adsorbed on Au-NPs@ZnO NSs excited by 632.8 nm. With reference to that observed in FIG. 8A, strong SERS bands of R6G were observed in this context. The SERS bands of R6G recorded are in Table 2, along with band assignment and corresponding simulated values. Interestingly, SERS bands of R6G were noted in addition to the Raman band of ZnO. As a reference, the Raman spectrum of Au-NPs@ZnO NSs without any R6G was recorded, as shown in FIG. 8B. Several Raman bands of ZnO, as indicated in FIG. 8B were observed, and all the bands coincided well with those observed in ZnO NSs.

The SERS spectra of R6G on Au-NPs@ZnO NSs and Raman spectrum of Au-NPs@ZnO NSs obtained solely at 632.8 nm excitation showed a fluorescence background, as illustrated in FIG. 8C and FIG. 8D. Insets of FIG. 8C and FIG. 8D show CCD pictures of the identical specimens, as well as the focused point highlighted by a white “x” that was utilized to generate the SERS and Raman spectra. The laser was shut off at 25% strength and turned off immediately after the measurement, as indicated in the experimental section, without moving the focusing spot on the same object.

TABLE 2
Raman modes recorded for the Au—NP@ ZnO NSs excluding
the bands of ZnO NSs and corresponding band assignments.

| | Experimental | Theoretical |
|---|---|---|
| Mode of Vibration | (cm⁻¹) | (cm⁻¹) |
| C—C stretching mode in xanthene ring | 1647 | 1652 |
| C—C stretching mode in phenyl ring | 1578 | 1577 |
| C—N stretching mode in NHC₂H₅ | 1510 | 1458 |
| C—C stretching in xanthene ring | 1310 | 1351 |
| C—H in-plane bending in xanthene ring | 1180 | 1192 |
| C—C op bend | 880 | 895 |
| C—C op bend | 766 | 771 |
| C—C op bend | 610 | 612 |

### Example 8: Calculations

The EM field plays a role in enhancing the Raman signal of molecules adsorbed on plasmonic nanostructures, leading to increased sensitivity and detection limits. When a molecule is adsorbed on a plasmonic substrate, such as Ag or Au NPs, an EM field is generated near the surface due to the excitation of localized surface plasmon resonances. In SERS enhancement, the EM field mechanism dominates the CT mechanism at least for several orders. Ensemble SERS enhancements which are on the order of 10⁵ to 10⁸, are mainly due to a twofold EM field enhancement as formulated in equation 3. Twofold electromagnetic (EM) enhancement refers to a phenomenon where the SERS or surface-enhanced resonance Raman scattering (SERRS) process exhibits a twofold increase in the enhancement of the Raman signal. It involves the coupling of plasmon resonance with both the excitation and emission processes, leading to an overall enhancement in the Raman signal.

The enhancement factor, M, is denoted by the following equation 3.

$$M = {\vert \frac{{E}_{L} ( {λ}_{I} )}{{E}_{I} ( {λ}_{I} )} \vert}^{2} \times {\vert \frac{{E}_{L} ( {λ}_{I} \pm {λ}_{R} )}{{E}_{I} ( {λ}_{I} \pm {λ}_{R} )} \vert}^{2} = {M}_{1} ( {λ}_{I} ) \times {M}_{2} ( {λ}_{I} \pm {λ}_{R} ) \qquad ( eq . 3 )$$

where E₁ and E_{L} are the incident and local electric fields respectively, λ₁ is the excitation wavelength, +A_{R} and −λ_{R} are the wavelengths of the anti-Stokes and Stokes Raman shifts, respectively, an M₁ and M₂ are the first and second enhancement factors, respectively.

ZnO nanostructures were shown to be less effective in inducing EM near-field and thus contributes less to SERS enhancement. On the contrary, noble metal nanostructures such as Au nanoparticles were shown to induce EM near-field and contribute higher to SERS enhancement.

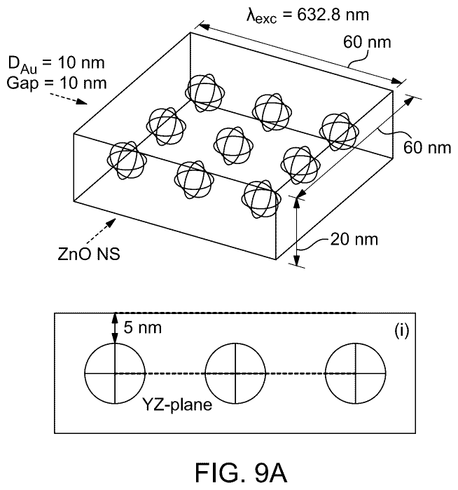

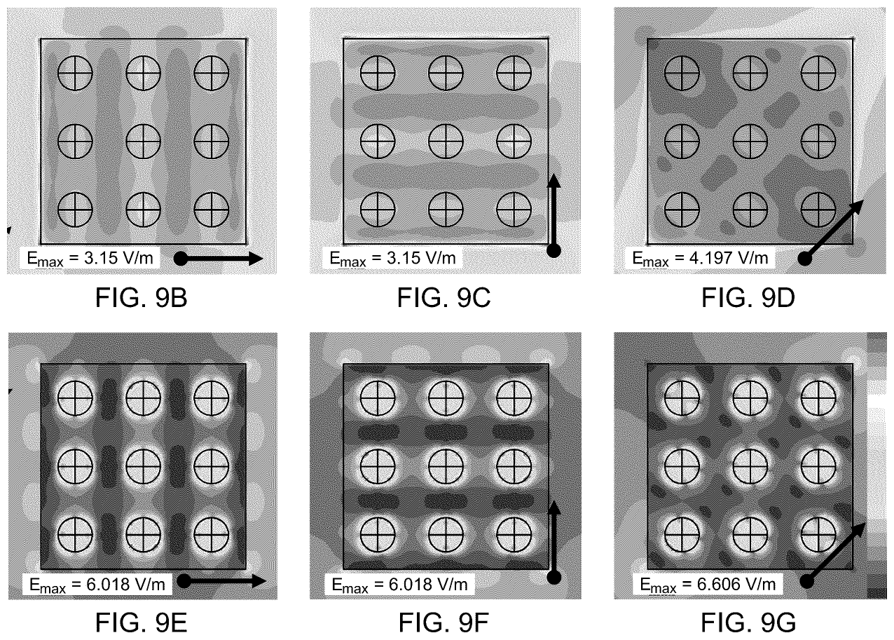

As mentioned earlier, SERS enhancement relies heavily on EM near-field distributions, and therefore, FDTD analysis was carried out to understand EM near-field distributions for a geometry, as shown in FIGS. 9A-9G. Based on a detailed investigation of morphology, as stated above in FIG. 4A and FIG. 6A, it was revealed that the Au NPs under this investigation were embedded in ZnO NSs rather than dispersed on the surface of NSs.

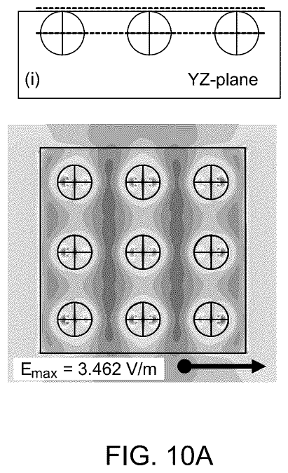

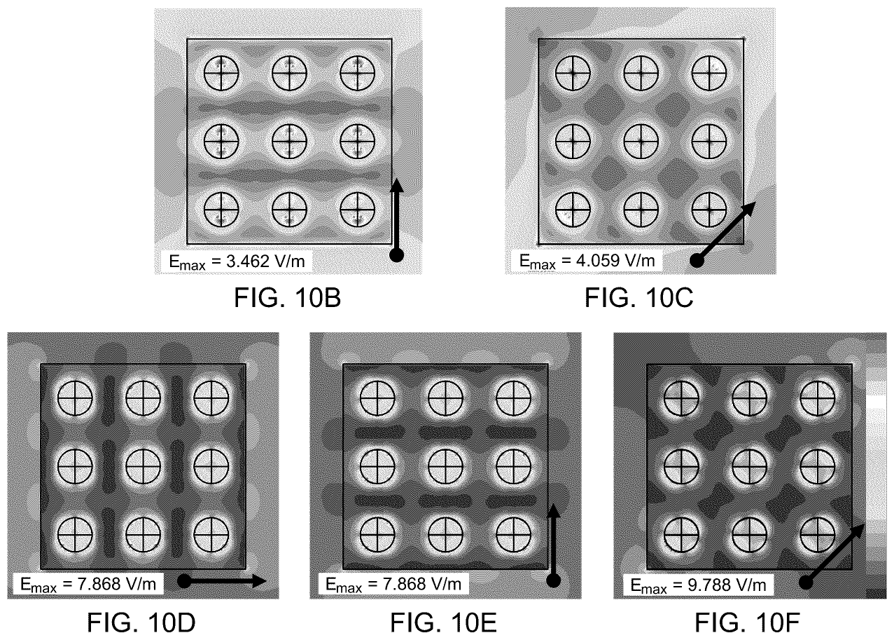

For the convenience of simulation as well as modeling, here in this work, the geometry was modeled by arranging small spherical Au nano-objects embedded inside a ZnO NS. A model resembling Au-NPs@ZnO NSs, as shown in FIG. 9A was used in this regard. The dimension and feature of the selected model were chosen, as mentioned therein, to facilitate insight into how EM near-field distributions get induced in such geometry because of excitation at different polarizations. Two different models, Au nano-objects placed at the center of the ZnO NS and Au nano-objects touched at the top surface of the ZnO NS as shown in inset (i) of FIG. 9A and inset (i) of FIG. 10A, respectively, were utilized for comparison as well.

FIGS. 9B-9D represent EM near-field distributions at XY (Z=10 nm) plane for a model geometry as shown in FIG. 9A and excited with incident excitation of s-, p- and 45° of incident polarizations respectively. In such a scenario, Au nano-objects 5 nm below the top surface of the ZnO NS, as shown in inset (i) of FIG. 9A. It was noteworthy that the EM near-field distributions with Eₘₐₓ=3.15 V/m were mostly confined at the two edges of the ZnO NS in the case of s-and p-polarizations, as shown in FIG. 9B and FIG. 9C respectively. On the other hand, in the case of oblique polarization, such as 45° of incident polarization, a bit higher EM near-field distributions (i.e., Eₘₐₓ=4.197 V/m) were noted at the two opposite corners of the ZnO NS as shown in FIG. 9D. However, the EM near-field distributions at the surface of Au nano-objects were found to be nearly twofold higher than those observed at the top surface of NS, as shown in FIGS. 9E-9F. FIGS. 9E-9F represent EM near-field distributions at XY (Z=0 nm) plane for a model geometry as shown in FIG. 9A and excited with incident excitation of s-, p- and 45° of incident polarizations respectively. It was noteworthy that the EM near-field distributions were mostly confined at the surface of Au nano-objects regardless of incident polarizations. Although the EM near-field distributions were found broadened and higher compared to those observed at the top surface of the ZnO NS, these EM near-field distributions will not contribute to SERS enhancement being unable to reach the target analyte.

The dispersion of Au NPs within the ZnO NS, particularly the position and interparticle gaps of such NPs, affects the EM near-field distribution and thus affects the SERS enhancement. Due to this reason, a model, as shown in the inset of FIG. 10A was developed wherein Au nano-objects were just touching the ZnO NS, keeping all other parameters the same. FIG. 10A-FIG. 10C displays EM near-field distributions at XY (Z=5 nm) plane for a model geometry, as shown in FIG. 10A and excited with incident excitation of s-, p- and 45° of incident polarizations respectively. In this particular case, Au nano-objects were just touching the top surface of the ZnO NS, as shown in inset (i) of FIG. 10A. It was noteworthy that the top surface of ZnO NS had distributed EM near-fields with Eₘₐₓ=3.462 V/m in the case of s-and p-polarizations, as shown in FIG. 10A and FIG. 10B, respectively. In the case of oblique polarization, such as 45° of incident polarization, higher EM near-field distributions (i.e., Eₘₐₓ=4.059 V/m) were noted at the two opposite corners of the ZnO NS along with distributed EM near-fields at the top of the ZnO NS as shown in FIG. 10C. The EM near-field distributions at the surface of Au nano-objects were found to be nearly two-fold higher than those observed at the top surface of ZnO NS, as shown in FIG. 10D-FIG. 10F. FIG. 10D-FIG. 10F represents EM near-field distributions at XY (Z=0 nm) plane for a model geometry, as shown in FIG. 10A and excited with incident excitation of s-, p-and 45° of incident polarizations respectively. Regardless of incident polarizations, it was notable that the majority of the EM near-field distributions were contained at the surface of Au nano-objects. Even while the EM near-field distributions were observed to be greater and broader than those seen at the surface of ZnO NS, it was not contributing to SERS enhancement. In contrast, Au NPs touching the top surface of ZnO NSs enabled higher distributions of EM near-field, which allowed Au NPs@ZnO NSs to have stronger SERS activity.

Numerous modifications and variations of the present disclosure are possible in light of the above teachings. Therefore, it is to be understood that within the scope of the appended claims, the invention may be practiced other than as specifically described herein.

1. A surface enhanced Raman spectroscopy (SERS) substrate, comprising:
a substrate;
zinc oxide nanosheets (ZnO NSs); and
gold nanoparticles,
wherein the ZnO NSs have an average thickness of 40-70 nm,
wherein the gold nanoparticles are embedded within the ZnO NSs to form a nanocomposite, and
wherein the nanocomposite is dispersed on a surface of the substrate to form the SERS substrate.

2. The SERS substrate of claim 1, wherein the ZnO NSs have a longest dimension of 0.5-2.0 μm.

3. The SERS substrate of claim 1, wherein the ZnO in the ZnO NSs has a wurtzite crystal structure.

4. The SERS substrate of claim 1, wherein gold is not doped within the crystal structure of the ZnO in the ZnO NSs.

5. The SERS substrate of claim 1, wherein gold nanoparticles comprise only gold.

6. The SERS substrate of claim 1, wherein gold nanoparticles are crystalline.

7. The SERS substrate of claim 1, wherein gold nanoparticles are spherical and have an average diameter of 1-20 nm.

8. The SERS substrate of claim 1, wherein the nanocomposite does not comprise a capping agent or a surfactant.

9. The SERS substrate of claim 1, wherein the nanocomposite is not aggregated on the surface of the substrate.

10. The method of claim 1, wherein the substrate is selected from the group consisting of glass, FTO, ITO, and AZO.

11. A method of making the nanocomposite of claim 1, comprising:
adding a zinc salt in a solvent to form a first solution;
adding hydrogen tetrachloroaurate in water to form a second solution;
mixing the first solution and the second solution and heating for less than 1 hour to form a reaction solution;
cooling the reaction solution to 5-10° C. in an absence of light for at least 24 hours to form the nanocomposite.

12. The method of claim 11, wherein the first solution has a concentration of 0.05-0.5 M of the zinc salt and the second solution has a concentration of 0.5-2 M of the hydrogen tetrachloroaurate.

13. The method of claim 12, wherein the reaction solution comprises a same volume of each of the first solution and the second solution.

14. A method of performing SERS, comprising:
coating the SERS substrate of claim 1 with a Raman dye; and
measuring a Raman signal of the Raman dye on the SERS substrate,
wherein an intensity of the Raman signal of the Raman dye is higher than a Raman signal of the Raman dye measured by the same method but without the SERS substrate.

15. The method of claim 14, wherein the measuring comprises irradiating with 600-700 nm light.

16. The method of claim 14, wherein the Raman signal is monitored from 200-1,800 cm⁻¹.

17. The method of claim 14, wherein the Raman dye is a rhodamine dye.

18. The method of claim 14, wherein the intensity of the Raman signal of the Raman dye is at least two times higher than the Raman signal of the Raman dye measured by the same method but without the SERS substrate.
